(19) United States
(12) Patent Application Publication
(10) Pub. No.: US 2008/0023973 A1
(43) Pub. Date: Jan. 31, 2008

(54) Implement with a foot pedal

(76) Inventor: Jordan Power Jackson, Austin, TX (US)

Correspondence Address: PATRICK STELLITANO, 2803 INRIDGE DR., AUSTIN, TX, 78745, US

(21) Appl. No.: 11/524,974

(22) Filed: Sep. 21, 2006

Related U.S. Application Data
(60) Provisional application No. 60/834,505, filed on Jul. 31, 2006.

(51) Int. Cl. A01B 1/00

(52) U.S. Cl. 294/60

(57) ABSTRACT

Apparatus and methods for improving a shovel-like implement are disclosed. A foot pedal or more than one foot pedal is mounted to or formed upon the blade of the shovel. In different embodiments, the foot pedals may be mounted to the head of the blade, to the side of the blade or to a surface of the blade. In some embodiments a foot pedal is removably attachable to the blade. In some embodiments, there is substantially no relative motion between the foot pedal and the blade. The foot pedal is ideally positioned to maximize the application of force through the foot pedal to the blade in the desired direction. The foot pedal is also ideally dimensioned to minimize injury and soreness to the foot.

### PRIORITY

This application claims priority of U.S. provisional application No. 60/834,505 filed on 31 Jul. 2006.

### FIELD

The present invention is in the field of long-handled tools such as shovel. In particular a foot pedal is provided to a tool to enable one to apply one's foot to the foot pedal to apply force.

### BACKGROUND

Shovels for shoveling matter are well known and indeed are practically ubiquitous. Many people have and use shovels. A well known problem with a shovel is the soreness to one's foot that develops over time when the foot is applied to the head of the shovel to apply a force to push the shovel into the matter to be shoveled. Conventionally, for example, the head of a spade may be bent over in to a small lip about ¼ to ⅜ inch wide. One places one's foot on this lip to apply downward force. In reaction, the lip digs a little into the bottom of one's foot. After a short while of repeated digging this way, the foot gets sore. In fact, some people have cause to see a doctor because of the intense soreness from digging. Also, one's foot tends to pivot about the lip causing a misdirection of force. What is needed is a shovel that does not cause soreness and further provides a more controlled way of applying force to the shovel.

### SUMMARY

The problems identified above are in large part addressed by an apparatus and method for shoveling matter. One embodiment comprises a foot pedal on the blade of the shovel. The foot of a person using the shovel is applied to the foot pedal, usually in a generally downward motion, to apply force to the shovel. Thus, to use a shovel described herein, one applies a foot to a foot pedal of the shovel. One then places his or her weight on that one foot, transferring force to the shovel through the foot pedal. Because the foot pedal is wide compared to the lip at the head of the shovel, the foot pedal provides to the foot a much broader platform against which the foot is pressed. This prevents the foot from easily becoming sore, and also provides better control over the direction of force applied to the shovel, resulting thereby in more efficient shoveling.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a shovel with a blade and foot pedal which can be one solid piece or the connection of two separate pieces.

FIG. 2 depicts an embodiment of a shovel with two foot pedals, one on each side of the handle of the shovel.

FIG. 3 depicts an embodiment of a foot pedal with one pattern of holes in the pedal to provide gripping with the sole of a shoe.

FIG. 4 depicts an embodiment of a foot pedal with raised protrusions to provide gripping with the sole of a shoe.

FIG. 5 depicts an embodiment of a foot pedal that is round with grooves and protrusions to provide gripping with the sole of a shoe.

FIG. 6 depicts an embodiment of a foot pedal that is wide and long and has a combination of grooves and holes to provide gripping with the sole of the shoe.

FIG. 7 depicts an embodiment of a foot pedal that is yet a different shape with different shaped holes.

FIG. 8 depicts an embodiment of a shovel with two foot pedals mounted at the head of the blade and a third foot pedal mounted on a side of the blade.

FIG. 9 depicts a side view of a foot pedal that is machined to couple with the blade of a shovel.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments; but, on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Apparatus and methods for improving a shovel-like implement are disclosed. A foot pedal or more than one foot pedal is mounted to or formed upon the blade of the shovel. In different embodiments, the foot pedals may be mounted to the head of the blade, to the side of the blade or to a surface of the blade. In some embodiments a foot pedal is removably attachable to the blade. In some embodiments, there is substantially no relative motion between the foot pedal and the blade. The foot pedal is ideally positioned to maximize the application of force through the foot pedal to the blade in the desired direction. The foot pedal is also ideally dimensioned to minimize injury and soreness to the foot.

FIG. 1 depicts an embodiment of a shovel with a blade and a foot pedal, which can be one solid piece or the connection of separate pieces. The shovel comprises a handle 102 and a blade 104. Typically, blade 104 has a relatively sharp edge 106 for cutting through matter. Blade 104 also, in a spade, ends at the bottom with a point 108. At the opposite end, blade 104 comprises a head 110. Typically, head 110 of blade 104 is bent into a lip about ⅜ inches wide or so to enable a foot to be pressed against the lip. The narrow gauge of the lip makes it difficult to accurately direct one's force in the desired direction. The narrow gauge of the lip also makes one's foot sore.

To solve these problems embodiments provide a foot pedal. In the example of FIG. 1, a foot pedal 112 is located at the head of the blade on one side of the handle. The foot pedal can be thin or of substantial thickness or of an intermediate thickness compared to the thickness of the blade. Foot pedal 112 could also be called a foot plate because it is plate like. Foot pedal 112 may be positioned to be at generally a right angle with a plane locally tangent with the blade. Thus, in one embodiment, foot pedal 112 is at right angles with the direction of the blade 104.

Note that for added safety, foot pedal 112 may comprise an application of rubber or other strong insulating material to prevent electric conduction to the foot in the event the blade cuts into a wire or cable. Thus, the foot pedal concept as shown herein enables the manufacture and use of a safety tool when it is necessary to dig, for example, in an area containing buried conductors. One method of insulating is simply to cover the portion of the foot pedal that comes into contact with the foot by an insulator. Another method is to provide a flexible thick cover that un-removably attaches to the top of the foot pedal.

Note also, that the blade in FIG. 1 is in the shape of a spade. This invention could also be applied to different shovel shapes such as a square headed shovel. A square headed shovel does not end in a point, but rather, ends in a long flat edge. Also, the term shovel as used herein encompasses any implement wherein a foot pedal applied to the working part of the implement provides objects and advantages as described herein. Thus, for example, the working part of the shovel may be a pitchfork or hoe shaped device.

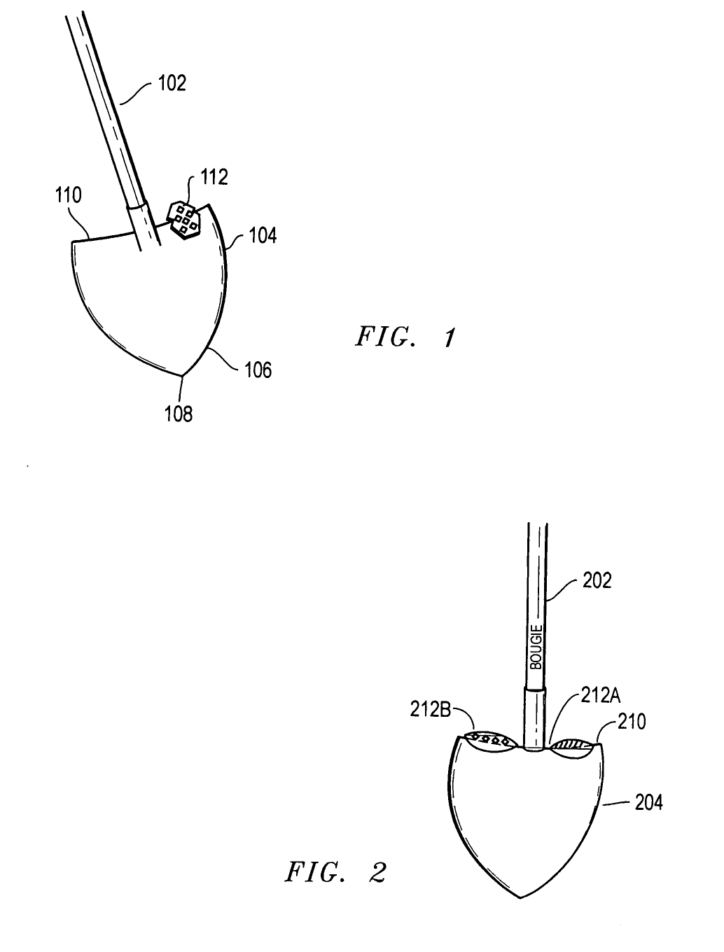

FIG. 2 depicts an embodiment of a shovel with two foot pedals mounted to the working part, one on each side of the handle of the shovel. The particular shovel FIG. 2 shows comprises a handle 202, a blade 204 and first foot pedal 212A and a second foot pedal 212B, each foot pedal mounted at the head 210 of blade 204. People who are right-handed may prefer to use their left foot on the left side of the shovel, thus applying force to pedal 212A, whereas people who are left-handed may prefer to use their right foot on the right side of the shovel, thus applying force to pedal 212B. Thus, the shovel of FIG. 1 may be called a right handled shovel, and the shovel of FIG. 2 may be called neutral. Also, with two pedals, one on each side of the handle, the worker can position the shovel substantially vertically and jump onto the shovel, landing each one of his feet on a foot pedal at about the same time.

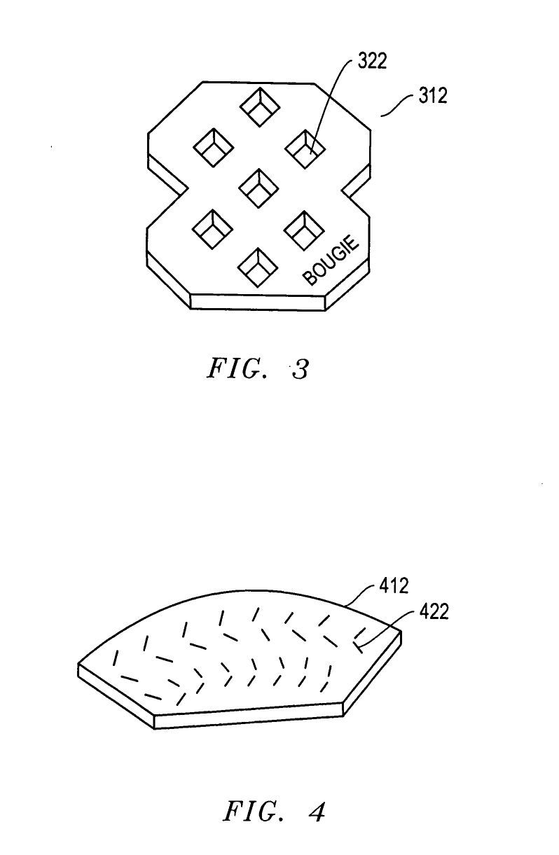

FIG. 3 depicts an embodiment of a foot pedal with one pattern of holes in the pedal to provide gripping with the sole of a shoe. When a person places his or her weight against the foot pedal 312, the sole of the shoe (or the bottom of a bare foot) grips the pedal by virtue of the holes 322. This produces traction and will keep the foot from slipping on the pedal.

FIG. 4 depicts an embodiment of a foot pedal with raised protrusions to provide gripping with the sole of a shoe. When a person places his or her weight against the foot pedal 412, the sole of the shoe (or the bottom of a bare foot) grips the raised protrusions 422. This provides traction and will keep the foot from slipping on the pedal.

FIG. 5 depicts an embodiment of a foot pedal 512 that is round with grooves 522 and protrusions 524 to provide gripping with the sole of a shoe. Clearly, different shapes of foot pedals may be tried to determine the best-feeling shape. Also, many different combinations of surface work, that is, grooves, protrusions and holes, may be tried to determine which provides the greatest traction. Also, sole may be applied to the foot pedal to prevent electrical shock and to provide traction. Thus, the invention, according to the claims below, will encompass many different types and shapes of a foot pedal. Note that the foot pedal also performs the function of providing a surface on which to place a trademark in prominent display.

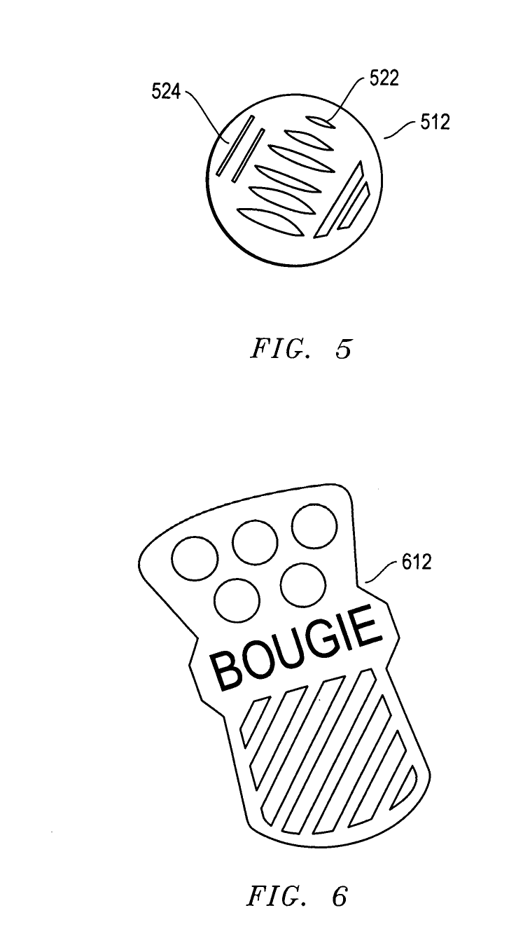

FIG. 6 depicts an embodiment of a foot pedal that is wide and long and has a combination of grooves and holes to provide gripping with the sole of the shoe. In the design of FIG. 6, the foot pedal 612 substantially, although not necessarily entirely, encompasses the bottom surface of the foot. This provides a broad surface against which to press the foot, resulting in less soreness and more accurate direction of the shovel. An ideal situation might be that the length of the pedal extends from the front ball to the rear ball of the foot. The width might also be optimized through ordinary experimentation.

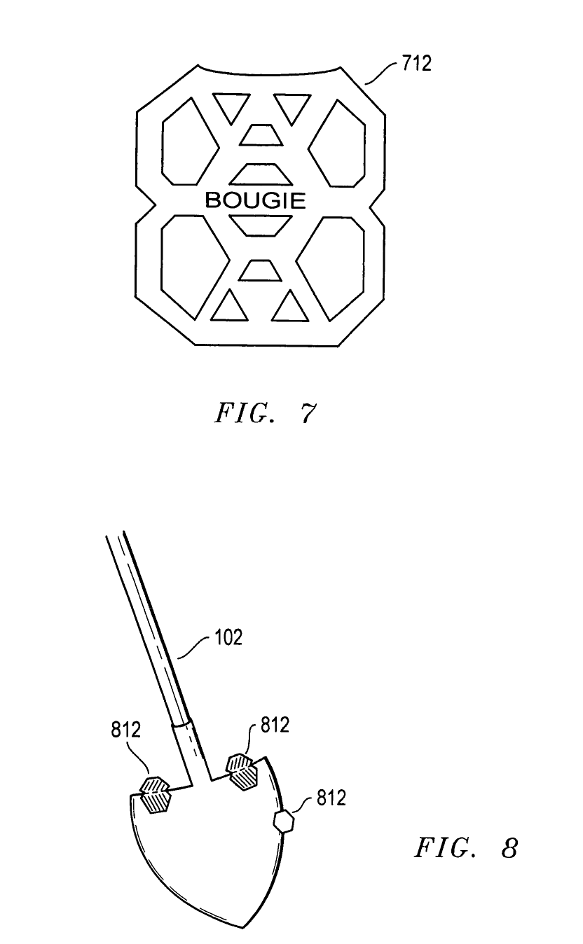

FIG. 7 depicts an embodiment of a foot pedal 712 that is yet a different shape with different shaped holes. In contrast to the embodiment of FIG. 6, the embodiment of FIG. 7 is about as long as it is wide. Clearly, the ratio of length to width can be adjusted to some optimum value. Also, different patterns of surface work on the pedal—holes and/or grooves and/or protrusions—can be employed for optimal gripping.

Note that a sole made of rubber or other similar material can be applied to a foot pedal to protect against electrical shock and to provide traction.

FIG. 8 depicts an embodiment of a shovel with two foot pedals 812 mounted at the head of the blade and a third foot pedal 812 mounted on a side of the blade. Thus, the head of the blade is not the only location to place a foot pedal. A foot pedal may be mounted on the side or on both sides instead of or in addition to foot pedals mounted at the head. Although a foot pedal can be mounted any convenient place on the blade, in the most common applications, simply providing one or two pedals at the head of the blade will work optimally.

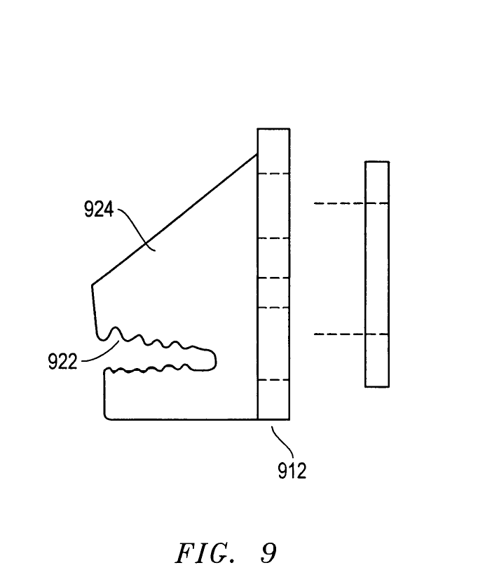

In the embodiments described above, the foot pedals can be mounted to the blade in a variety of ways. For example, the blade and foot pedal(s) may be molded or cast as one continuous piece of metal. Or the pedal may be fused into position on the blade by, for example, welding. Or the pedal may be attached to a pre-formed blade by any means of attachment sufficient to secure the pedal to the blade. FIG. 9 depicts a side view of a foot pedal 912 that is machined to couple with the blade of a shovel. Foot pedal 912 comprises a ridge-like protrusion 924 with a jaw 922 that couples to a corresponding surface on the blade. Embodiments are not limited to one coupling method but rather encompass many conceivable coupling mechanisms to couple a foot pedal to a blade of a shovel. In some embodiments, for example, the foot pedal is removably coupled to the blade. In some embodiments, the foot pedal is coupled to the blade so that there is substantially no relative motion between the foot pedal and the blade. In other embodiments, the foot pedal is pivotally mounted on the blade.

Although the present invention and some of its advantages have been described in detail for some embodiments, it should be understood that various changes, substitutions and alterations can be made herein without departing from the spirit and scope of the invention as defined by the appended claims. Although an embodiment of the invention may achieve multiple objectives, not every embodiment falling within the scope of the attached claims will achieve every objective. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A shovel, comprising:
a shovel blade;
the shovel blade comprising at least one foot pedal positioned on the blade to receive one's foot when shoveling.

2. The shovel of claim 1, wherein a plurality of foot pedals are positioned on the blade.

3. The shovel of claim 1, wherein the foot pedal and the blade are cast from a single piece of metal.

4. The shovel of claim 1, wherein the foot pedal is welded to the blade.

5. The shovel of claim 1, wherein a foot pedal is attachable to the blade.

6. The shovel of claim 1, wherein a foot pedal is pivotally mounted on a blade.

7. The shovel of claim 1, wherein there is substantially no relative motion between the foot pedal and the blade.

8. The shovel of claim 1, wherein a foot pedal exhibits a width and a length that provides a broad platform for a foot.

9. The shovel of claim 1, wherein a foot pedal exhibits surface work to provide gripping between the foot pedal and the sole of a shoe.

10. The shovel of claim 1, wherein a foot pedal is substantially perpendicular to a direction of the blade.

11. The shovel of claim 1, wherein a foot pedal is treated with a strong insulator to prevent electrical shock.

12. An implement, comprising:
a handle, and at a bottom end of the handle, a working part of the implement; and
at least one foot pedal, the foot pedal part of the working part of the implement to enable a user to apply his or her foot to the foot pedal to concentrate force through the foot and foot pedal to the working part of the implement.

13. The implement of claim 12, wherein a foot pedal is substantially stationary relative to the working part of the implement.

14. The implement of claim 12, wherein a foot pedal is crafted to provide gripping between the foot pedal and a shoe.

15. The implement of claim 12, wherein a foot pedal is long enough and wide enough to encompass a substantial portion of the foot.

16. The implement of claim 12, wherein the working part is a square point shovel.

17. A method for improving the performance of a shovel, comprising:
forming on a blade of the shovel a foot pedal, the foot pedal dimensioned to provide sufficient support to a foot of a user so that a force applied by the foot of the user to the foot pedal is distributed over the surface of the foot pedal to reduce soreness to the foot and increase directivity of force applied to the shovel.

18. The method of claim 17, further comprising forming surface work in the foot pedal to provide gripping between the foot pedal and a shoe applied against the foot pedal.

19. The method of claim 17, further comprising orienting a plane of the foot pedal to be substantially perpendicular to a direction of the shovel.

20. The method of claim 17, further comprising forming the foot pedal on the blade so that there is substantially no relative motion between the foot pedal and the blade.
